(19) United States
(12) Patent Application Publication
(10) Pub. No.: US 2026/0281774 A1
(43) Pub. Date: Sep. 17, 2026

(54) TECHNIQUES FOR RECEIVE BEAM REPORTING FOR WIRELESS COMMUNICATIONS

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US)

(21) Appl. No.: 19/168,764

(22) PCT Filed: Jun. 1, 2023
(86) PCT No.: PCT/CN2023/097693

§ 371 Date: Sep. 24, 2025

(51) Int. Cl. H04W 24/10; H04L 5/00; H04W 72/044; H04W 72/51

(52) U.S. Cl. CPC H04W 24/10; H04L 5/0053; H04W 72/046; H04W 72/51

(57) ABSTRACT

Methods, systems, and devices for wireless communications are described that provide for measurement reports that include UE receive beam information. The measurement reports may include measurement values and information on a receive beam that was used for the measurements. Receive beam information may include a beam level indication that provides a receive beam level in terms of receive array gain or maximum beamforming gain, in terms of whether the beam is an omni, wide, or narrow beam, or any combinations thereof. UE receive beam information may be reported for each channel measurement resource (CMR) based on a reporting format for the measurement report.

### CROSS REFERENCE

The present Application is a 371 national phase filing of International PCT Application No. PCT/CN2023/097693 by LI et al., entitled “TECHNIQUES FOR RECEIVE BEAM REPORTING FOR WIRELESS COMMUNICATIONS,” filed Jun. 1, 2023, which is assigned to the assignee hereof, and which is expressly incorporated by reference in its entirety herein.

### FIELD OF TECHNOLOGY

The following relates to wireless communications, including techniques for receive beam reporting for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for receive beam reporting for wireless communications. For example, the described techniques provide for requests for beam reports that include UE receive beam information, and measurement reports that include measurement values and information on a receive beam that was used for the measurement. In some aspects, a measurement report may include a beam level indication and a beam identification of the receive beam used for a measurement. In some cases, the beam level indication may provide a receive beam level in terms of receive array gain or maximum beamforming gain, in terms of omni/wide/narrow beam, a panel-ID used for the associated measurement, a measurement type of the receive beams (e.g., whether multiple receive beams or a single receive beam was used), or any combinations thereof. In some cases, UE receive beam information may be reported for each channel measurement resource (CMR) (e.g., synchronization signal block (SSB) or channel state information reference signal (CSI-RS) resources) based on a reporting format for the measurement report.

Further, in some cases, a network entity provide a joint transmission configuration indicator (TCI) state to the UE based on the reported UE receive beams, which may be used for subsequent communications. Such an indication may provide the level indication of the UE beam (e.g., wide/narrow beam, array gain), and the UE may determine the receive beams associated with the indicated TCI state. In some cases, the UE may provide a capability indication to the network that the UE is able to provide UE receive beam information, and whether the UE is able to receive associated TCI state information for subsequent time instances.

A method for wireless communications at a user equipment (UE) is described. The method may include receiving a request for a beam report for a set of channel measurement resources, the request including a UE beam information request for one or more receive beams used for one or more measurements of at least a subset of the set of channel measurement resources, measuring each measurement resource of the set of channel measurement resources using one or more receive beams, and transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

An apparatus for wireless communications at a UE is described. The apparatus may include at least one processor, at least one memory coupled with the at least one processor, and instructions stored in the at least one memory. The instructions may be executable by the at least one processor to cause the apparatus to receive a request for a beam report for a set of channel measurement resources, the request including a UE beam information request for one or more receive beams used for one or more measurements of at least a subset of the set of channel measurement resources, measure each measurement resource of the set of channel measurement resources using one or more receive beams, and transmit a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

Another apparatus for wireless communications at a UE is described. The apparatus may include means for receiving a request for a beam report for a set of channel measurement resources, the request including a UE beam information request for one or more receive beams used for one or more measurements of at least a subset of the set of channel measurement resources, means for measuring each measurement resource of the set of channel measurement resources using one or more receive beams, and means for transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

A non-transitory computer-readable medium storing code for wireless communications at a UE is described. The code may include instructions executable by a processor to receive a request for a beam report for a set of channel measurement resources, the request including a UE beam information request for one or more receive beams used for one or more measurements of at least a subset of the set of channel measurement resources, measure each measurement resource of the set of channel measurement resources using one or more receive beams, and transmit a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

In some examples of the method, apparatuses, and non-transitory computer-readable medium described herein, the beam level indication indicates one or more of a beam width of the receive beam or an array gain of the receive beam, where the beam width is indicated based on two or more beam width thresholds, and the array gain is indicated based on two or more array gain thresholds. In some examples of the method, apparatuses, and non-transitory computer-readable medium described herein, the measurement report further includes one or more of an antenna panel identification of the receive beam, a measurement type of the receive beam, or any combinations thereof. In some examples of the method, apparatuses, and non-transitory computer-readable medium described herein, the antenna panel identification indicates one or more antenna panels used at the UE for the receive beam. In some examples of the method, apparatuses, and non-transitory computer-readable medium described herein, the measurement type indicates a first measurement type associated with two or more receive beams that are associated with the corresponding measurement, or a second measurement type that indicates a single receive beam is associated with the corresponding measurement.

Some examples of the method, apparatuses, and non-transitory computer-readable medium described herein may further include operations, features, means, or instructions for identifying one or more candidate beam level indications for one or more receive beams used for the one or more corresponding measurements of at least the subset of the set of channel measurement resources, the candidate beam level indications based on one or more predefined threshold beam widths, one or more configured beam levels and associated beam widths, or one or more UE-selected beam levels and associated beam widths and determining which of the one or more candidate beam level indications to provide with one or more measurements of the measurement report based on the beam width of the receive beam associated with the one or more measurements.

Some examples of the method, apparatuses, and non-transitory computer-readable medium described herein may further include operations, features, means, or instructions for transmitting one or more of an indication of a total quantity of antenna panels at the UE, or an indication of one or more measurement types that can be reported by the UE. Some examples of the method, apparatuses, and non-transitory computer-readable medium described herein may further include operations, features, means, or instructions for receiving configuration information for one or more receive beam parameters to be reported with the measurement report during an initial access procedure. Some examples of the method, apparatuses, and non-transitory computer-readable medium described herein may further include operations, features, means, or instructions for receiving configuration information for one or more receive beam parameters to be reported with the measurement report as part of a channel state information report configuration.

In some examples of the method, apparatuses, and non-transitory computer-readable medium described herein, the measurement report includes one or more fields for the beam level indication and the beam identification of the receive beam, the one or more fields being predefined fields or network configured fields, where the one or more fields are each associated with a single channel measurement resource or are associated with all of the channel measurement resources of at least the subset of the set of channel measurement resources. In some examples of the method, apparatuses, and non-transitory computer-readable medium described herein, the measurement report may be provided with a channel state information (CSI) part-1 report, with a CSI part-2 report, or any combinations thereof.

Some examples of the method, apparatuses, and non-transitory computer-readable medium described herein may further include operations, features, means, or instructions for receiving an indication of a transmission configuration indicator (TCI) state for one or more subsequent communications, the TCI state indicating a joint TCI state associated with a transmit beam from a network entity and a receive beam at the UE. In some examples of the method, apparatuses, and non-transitory computer-readable medium described herein, the receive beam at the UE is indicated by one or more of a beam level indication or an antenna panel identification, and the UE determines the indicated receive beam based on one or more reported beam level indications or antenna panel identifications provided in one or more measurement reports.

Some examples of the method, apparatuses, and non-transitory computer-readable medium described herein may further include operations, features, means, or instructions for transmitting UE capability information that indicates a UE capability related to receive beam reporting associated with measurements in a measurement report. In some examples of the method, apparatuses, and non-transitory computer-readable medium described herein, the UE capability information further indicates a UE capability to receive an indication of a transmission configuration indicator state for UE receive beams for one or more subsequent communications.

A method for wireless communications at a network entity is described. The method may include transmitting, to a UE, a request for a beam report for a set of channel measurement resources, the request including a UE beam information request for one or more receive beams used at the UE for one or more measurements of at least a subset of the set of channel measurement resources and receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

An apparatus for wireless communications at a network entity is described. The apparatus may include at least one processor, at least one memory coupled with the at least one processor, and instructions stored in the at least one memory. The instructions may be executable by the at least one processor to cause the apparatus to transmit, to a UE, a request for a beam report for a set of channel measurement resources, the request including a UE beam information request for one or more receive beams used at the UE for one or more measurements of at least a subset of the set of channel measurement resources and receive a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

Another apparatus for wireless communications at a network entity is described. The apparatus may include means for transmitting, to a UE, a request for a beam report for a set of channel measurement resources, the request including a UE beam information request for one or more receive beams used at the UE for one or more measurements of at least a subset of the set of channel measurement resources and means for receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

A non-transitory computer-readable medium storing code for wireless communications at a network entity is described. The code may include instructions executable by a processor to transmit, to a UE, a request for a beam report for a set of channel measurement resources, the request including a UE beam information request for one or more receive beams used at the UE for one or more measurements of at least a subset of the set of channel measurement resources and receive a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

In some examples of the method, apparatuses, and non-transitory computer-readable medium described herein, the beam level indication indicates one or more of a beam width of the receive beam or an array gain of the receive beam, where the beam width is indicated based on two or more beam width thresholds, and the array gain is indicated based on two or more array gain thresholds. In some examples of the method, apparatuses, and non-transitory computer-readable medium described herein, the measurement report further includes one or more of an antenna panel identification of the receive beam, a measurement type of the receive beam, or any combinations thereof. In some examples of the method, apparatuses, and non-transitory computer-readable medium described herein, the antenna panel identification indicates one or more antenna panels used at the UE for the receive beam. In some examples of the method, apparatuses, and non-transitory computer-readable medium described herein, the measurement type indicates a first measurement type associated with two or more receive beams that are associated with the corresponding measurement, or a second measurement type that indicates a single receive beam is associated with the corresponding measurement.

Some examples of the method, apparatuses, and non-transitory computer-readable medium described herein may further include operations, features, means, or instructions for identifying one or more candidate beam level indications for one or more receive beams used for the one or more corresponding measurements of at least the subset of the set of channel measurement resources, the candidate beam level indications based on one or more predefined threshold beam widths, one or more configured beam levels and associated beam widths, or one or more UE-selected beam levels and associated beam widths and determining a beam width of each receive beam used at the UE for the one or more corresponding measurements for at least the subset of the set of channel measurement resources based on the one or more candidate beam level indications.

Some examples of the method, apparatuses, and non-transitory computer-readable medium described herein may further include operations, features, means, or instructions for transmitting configuration information for one or more receive beam parameters to be reported with the measurement report during an initial access procedure. Some examples of the method, apparatuses, and non-transitory computer-readable medium described herein may further include operations, features, means, or instructions for transmitting an indication of a TCI state for one or more subsequent communications, the TCI state indicating a joint TCI state associated with a transmit beam from the network entity and the receive beam at the UE. Some examples of the method, apparatuses, and non-transitory computer-readable medium described herein may further include operations, features, means, or instructions for receiving UE capability information that indicates a UE capability related to receive beam reporting associated with measurements in a measurement report.

### BRIEF DESCRIPTION OF THE DRAWINGS

FIG. 1 shows an example of a wireless communications system that supports techniques for receive beam reporting for wireless communications in accordance with one or more aspects of the present disclosure.

FIG. 2 shows an example of a portion of a wireless communications system that supports techniques for receive beam reporting for wireless communications in accordance with one or more aspects of the present disclosure.

FIG. 3 shows an example of a wireless communications system with different receive beam levels that support techniques for receive beam reporting for wireless communications in accordance with one or more aspects of the present disclosure.

FIG. 4 shows an example of a process flow that supports techniques for receive beam reporting for wireless communications in accordance with one or more aspects of the present disclosure.

FIGS. 5 and 6 show block diagrams of devices that support techniques for receive beam reporting for wireless communications in accordance with one or more aspects of the present disclosure.

FIG. 7 shows a block diagram of a communications manager that supports techniques for receive beam reporting for wireless communications in accordance with one or more aspects of the present disclosure.

FIG. 8 shows a diagram of a system including a device that supports techniques for receive beam reporting for wireless communications in accordance with one or more aspects of the present disclosure.

FIGS. 9 and 10 show block diagrams of devices that support techniques for receive beam reporting for wireless communications in accordance with one or more aspects of the present disclosure.

FIG. 11 shows a block diagram of a communications manager that supports techniques for receive beam reporting for wireless communications in accordance with one or more aspects of the present disclosure.

FIG. 12 shows a diagram of a system including a device that supports techniques for receive beam reporting for wireless communications in accordance with one or more aspects of the present disclosure.

FIGS. 13 through 22 show flowcharts illustrating methods that support techniques for receive beam reporting for wireless communications in accordance with one or more aspects of the present disclosure.

### DETAILED DESCRIPTION

In higher band communications, beamforming is often relied on to enhance channel gain. As transmitters and receivers move relative to each other, beams used for communications may need to be updated in order to provide for reliable communications. Thus, selected beams for communications between a transmitter and a receiver may change over time. In some cases, a network entity or a user equipment (UE) may use one or more models, such as artificial intelligence (AI) or machine learning (ML) models, to predict a beam that should be used at some future time instance (e.g., a future transmission configuration indicator (TCI) state for communications). For example, if a UE is moving at a relatively constant rate relative to a serving cell, one or more future beams may be predicted and beam switching based on the prediction may enhance communications throughput and reliability between the UE and the network. In some cases, it may be beneficial for such modeling and prediction to be performed at a network entity. However, in order to provide enhanced reliability in predictions, it may be useful for the network entity to have measurement information for different network-side beams and different UE-side beams, as well as information related to the UE-side receive beams. Some non-limiting examples of receive beam information include pointing direction, beam-width, quantity of antenna elements, antenna panel identification, and beamforming gain.

In current systems, UE measurement reports include information related to channel measurement resources (CMRs) that are measured (e.g., a synchronization signal block (SSB) or channel state information reference signal (CSI-RS)) and the associated measurement, and does not provide information related to the receive beam used at the UE to perform the measurement. However, providing detailed UE receive beam information may use a relatively large amount of data and air-interface resources. Additionally, providing detailed UE receive beam information may expose some UE proprietary information related to antenna configuration and selection algorithms. Thus, techniques for providing UE receive beam information with associated measurements in an efficient manner that does not divulge proprietary details are desirable.

In accordance with various aspects discussed herein, signaling is provided for a network entity to request UE-side receive beam information, and for UE reporting of beam information along with reported measurement information. In some cases, the UE beam information may be relatively coarse information (as opposed to detailed beam information) that provides sufficient information for AI/ML models to provide reliable predictions while having relatively low overhead and not disclosing information that may reveal proprietary UE details. The coarse information may include, for example, receive beam level in terms of receive array gain or maximum beamforming gain, or in terms of omni, wide, or narrow beam width; a panel-ID used to for the measurement(s) (e.g., layer 1 (L1) reference signal received power (RSRP) measurements, and/or L1 signal to interference and noise ratio (SINR) measurements), and/or a measurement type of the receive beam (e.g., whether multiple receive beams or a single receive beam was used). Beam levels may be predefined in a standard (e.g., based on a 3 dB beam width), may be configured by the network entity, or autonomously identified at the UE. Similarly, array gain thresholds may be defined in a standard, configured by the network entity, or identified at the UE. The UE receive beam information may be reported for each CMR based on a predefined reporting format, or for CMRs where the network requests the information. In some cases, the receive beam information may be jointly reported and apply to multiple measurements in a provided measurement report (e.g., if the UE uses the same L1 beam for all measurements).

In some cases, the network entity may use the measurement report and receive beam information provided by the UE to identify one or more time domain (TD) TCI states for one or more future time periods, and may provide a joint TCI state to the UE, which may be used for subsequent communications. In some cases, the joint TCI state may provide the level indication of the UE beam (e.g., wide/narrow beam and/or array gain), and the UE may determine which of the reported UE receive beams is associated with the indicated TCI state. Additionally, or alternatively, the UE may provide a capability indication to the network that the UE is able to provide UE beam information, whether the UE is able to receive associated TCI state information for subsequent time instances, or both.

As used herein, the term “receive beam,” or “Rx beam,” refers to a spatial path formed through beamforming techniques to shape or steer signals of two or more antennas such that a gain of received signals from a transmitting device along the spatial path is higher than a gain of received signals outside of the spatial path. Beamforming may be achieved by combining the signals received via antenna elements of an antenna array such that some signals propagating along particular orientations with respect to the antenna array experience constructive interference while others experience destructive interference. The adjustment of signals received via the antenna elements may include a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the receiving device, or with respect to some other orientation).

Techniques as discussed herein thus provide for enhanced operation of AI/ML algorithms at a network entity through information related to UE receive beams that are used for measurements in a measurement report. The network entity may use such information to provide enhanced predictions for future TCI states, which may enhance network efficiency, reliability, and throughput. UE beam information may be provided at a coarse enough level that UE implementation details may not be revealed. Further, the beam information provided in accordance with various aspects adds a relatively small amount of reporting overhead, while still allowing for network-side beam prediction.

Aspects of the disclosure are initially described in the context of wireless communications systems. Aspects of the disclosure are further illustrated by and described with reference to process flows, apparatus diagrams, system diagrams, and flowcharts that relate to techniques for receive beam reporting for wireless communications.

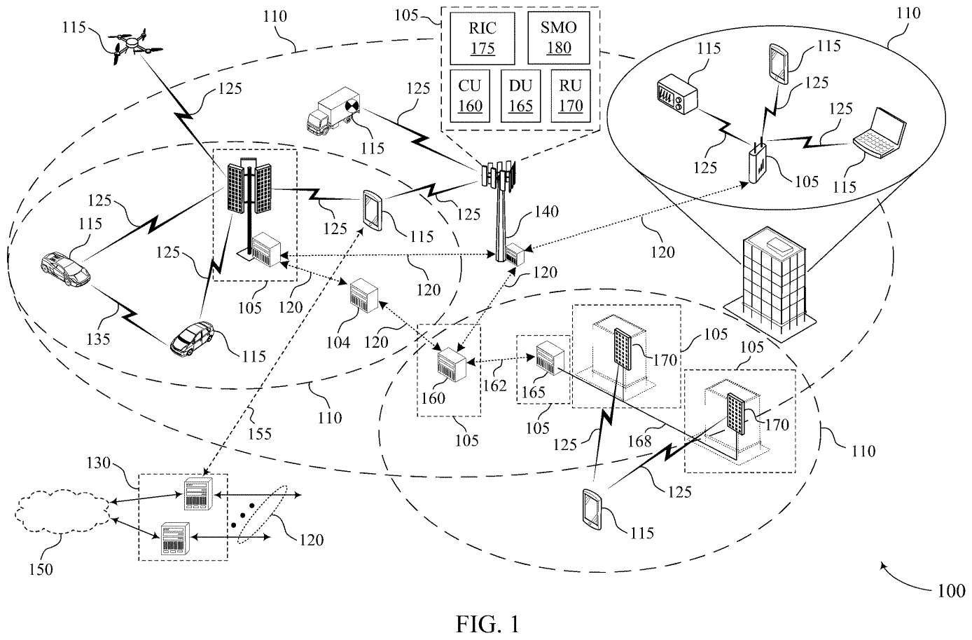

FIG. 1 shows an example of a wireless communications system 100 that supports techniques for receive beam reporting for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for receive beam reporting for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, one or more UEs 115 may provide measurement reports (e.g., CSI reports) to one or more network entities 105. In accordance with techniques described herein, a network entity 105 may request a beam report that includes UE 115 receive beam information, and a UE 115 may transmit a measurement report that include measurement values and information on one or more receive beams for the measurement values. In some aspects, a measurement report may include a beam level indication of the receive beam used for a measurement. In some cases, the beam level indication may provide a receive beam level in terms of receive array gain or maximum beamforming gain, or in terms of omni/wide/narrow beam. In some cases, beam information may include, additionally or alternatively, a panel-ID used for the associated measurement, a measurement type of the receive beams (e.g., whether multiple receive beams or a single receive beam was used), or any combinations thereof. In some cases, UE 115 receive beam information may be reported for each CMR (e.g., SSB or CSI-RS resources) based on a reporting format for the measurement report.

Further, in some cases, a network entity 105 provide a joint TCI state to the UE 115 based on the reported UE 115 receive beams, which may be used for subsequent communications. Such an indication may provide the level indication of the UE-side beam (e.g., wide/narrow beam, array gain), and the UE 115 may determine the receive beams associated with the indicated TCI state. In some cases, the UE 115 may provide a capability indication to the network that the UE 115 is able to provide UE 115 receive beam information, and whether the UE 115 is able to receive associated TCI state information for subsequent time instances.

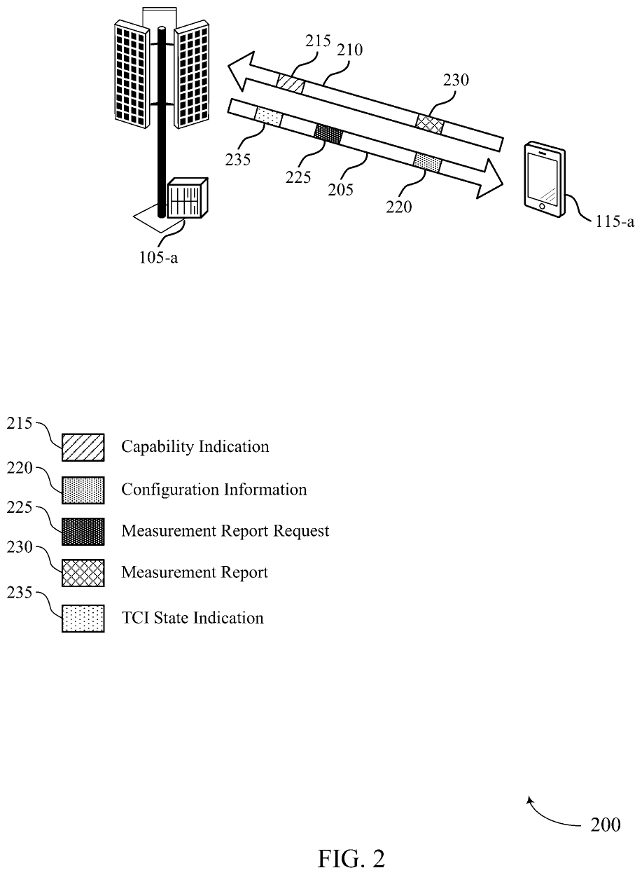

FIG. 2 shows an example of a wireless communications system 200 that supports techniques for receive beam reporting for wireless communications in accordance with one or more aspects of the present disclosure. In some examples, the wireless communications system 200 may implement aspects of a wireless communications system 100. For example, the wireless communications system 200 may include a network entity 105-a and a UE 115-a which may be examples of corresponding devices as described with reference to FIG. 1.

In some examples, the network entity 105-a (e.g., a network entity 105 of FIG. 1) may communicate with UE 115-a via downlink channel 205 and uplink channel 210. For example, downlink channel 205 and uplink channel 210 may be carried by downlink and uplink component carriers, or may be provided using TDD on one or more component carriers. In accordance with various techniques herein, the UE 115-a may have a capability to provide receive beam information along with measurement information in a measurement report, and in some cases may provide an indication of such a capability in a capability indication 215 that is provided to the network entity 105-a. The network entity 105-a may provide configuration information 220 to the UE 115-a that indicates configuration parameters for reporting of UE receive beam information. For example, the configuration information 220 may enable or disable receive beam information indications with measurement reports, may provide one or more threshold values for different receive beam level indicators, and may configure CSI part-1 and/or part-2 report parameters, for example. The network entity 105-a, based on the configured reporting, may transmit a measurement report request 225 to the UE 115-a. In some cases, the measurement report request 225 may be a trigger for generation and transmission of measurement report 230, which may include measurement information and beam information for the UE 115-a. In some cases, the network entity 105-a may use the information in the measurement report 230 to identify one or multiple TCI states in the time domain for future communications.

As discussed herein, in some cases the beam information provided with the measurement report 230 may be coarse receive beam information with respect to reported L1-RSRP measurements. For example, the receive beam information may indicate a beam level in terms of receive antenna array gain or maximum beamforming gain; or in terms of beam width (e.g., omni, wide, or narrow). Additionally, or alternatively, the receive beam information may include one or more of an antenna panel-ID used to measure L1-RSRPs, or a measurement type (e.g., whether a single or multiple beams are associated with a measurement.

For example, to reduce UE 115-a power consumption for beam management, wide receive beams may be more frequently used to measure L1-RSRPs, while narrow receive beams may be only occasionally used, and UE 115-a may report such receive beam level/type used to measure the reported L1-RSRPs in L1 reports. Depending on desired throughput, the network entity 105-a may predict an appropriate transmit beam together with the associated receive beam level/type for future time domain occasions based on such UE 115-a reports, and signal such predicted transmit beam and receive beam level/type via TCI state indication 235.

In some cases, the UE 115-a may be requested by the network entity 105-a to report measured L1-RSRPs/L1-SINRs regarding a set of CMRs (e.g., SSBs/CSI-RSs), and the network entity 105-a request (e.g., measurement report request 225) includes an indication that the UE 115-a is to report information on the receive beams associated with the respective measured L1-RSRPs/L1-SINRs. In some cases, the network entity 105-a requested feedback can be based on a CSI report setting, uplink medium access control (MAC) control elements (CEs), RRC messages, or user-plane protocols.

In some cases, the information on the receive beams may include relatively coarse receive beam information, which may include one or more of a level indication, an antenna panel identification, or a measurement type. The level indication of the receive beam(s) associated with a certain reported L1-RSRP/L1-SINR, in some cases, may be based on two or more candidate levels of receive beams are defined based on at least one a beam width (e.g., 3 dB beam-width) or array gain. In some cases, beam-width thresholds for each level can be predefined, configured/indicated in configuration information 220, UE 115-a reported, or UE 115-a autonomously identified and transparent to the network entity 105-a. Array gain, thresholds for each level also may be predefined, configured/indicated in configuration information 220, UE 115-a reported, or UE 115-a autonomously identified and transparent to network entity 105-a. The antenna panel identification may include a panel-ID of the receive beam(s) associated with one or more reported L1-RSRP/L1-SINR. The measurement type of the receive beam(s) associated with one or more reported L1-RSRP/L1-SINR may include, for example, Type #1 (multiple Rx beams) where the reported measurement is associated with multiple receive beams historically used (e.g., based on TD/SD filtering); or Type #2 (single Rx beam) where the reported measurement is associated only with a single receive beam. In some cases, Type #2 may include Type #2A, where the results are further based on TD filtering associated with multiple historical measurements; or Type #2B where the results are based on only instantaneous measurement.

When reporting such beam level indications, the two or more different levels for beam information may be identified based on two or more candidate levels that may be reported. For example, for the level indication of the receive beam(s), a first option may be to have candidate levels predefined, where a standard document identifies a number of levels and threshold values associated each level. A second option may be that candidate levels are network entity 115-a configured/indicated, where the configuration/indication can be based on selection of a number of predefined candidate levels, or configuration of a number of levels, as well as their associated threshold values. A third option may be that if candidate levels are UE 115-a reported, the UE 115-a may report can be based on selecting a number of predefined candidate levels as described in the first option, or reporting a number of levels, as well as their associated threshold values. A fourth option may be that if candidate levels are UE 115-a autonomously identified and transparent to the network entity 105-a, the UE 115-a may still report the total number of candidate levels.

In some cases, for the panel-ID of the receive beam(s), the total number of candidate panels may be reported by UE. In some cases, for the measurement type of the receive beam(s), the UE may to pre-report the measurement types that it would address in the requested measurement report, while mapping between a codepoint in the UE 115-a reported beam information and a specific measurement type may be predefined. In some cases, enabling of UE 115-a beam information reporting and configuration of beam information reporting may be based on the capability indication 215, which may be provided during initial access. In some cases, if the UE 115-a L1-RSRP/L1-SINR is associated with a CSI report setting, the configuration/indication can be based on RRC configuration associated with the CSI report setting, or RRC configuration (e.g., associated with CSI-AssocaitedReportConfigInfo if the CSI report is aperiodic), or MAC-CE activating the CSI report if the CSI report is semi-persistent, or dedicated MAC-CE, or dedicated downlink control information field(s).

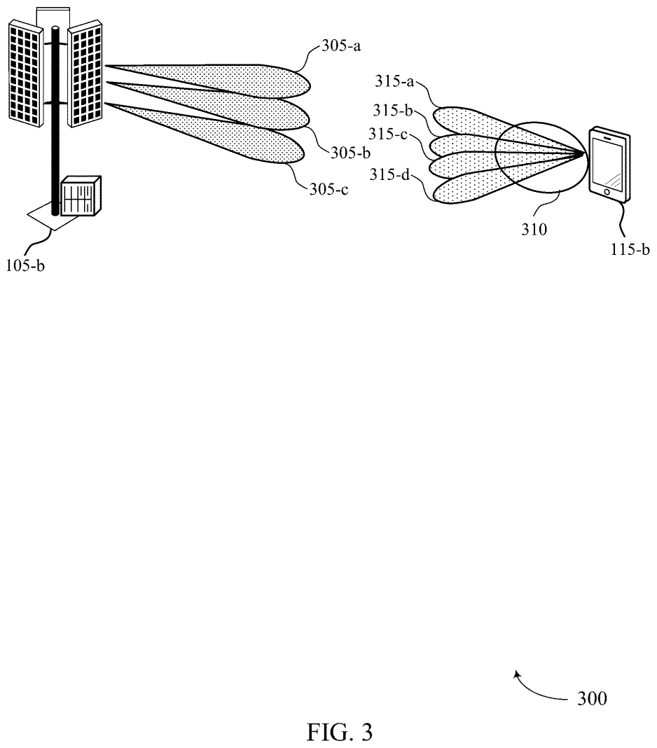

In some cases, the measurement report 230 may reported as a part of the CSI report payload. For example, for each UE 115-a reported L1-RSRP/L1-SINR associated with a certain SSB/CSI-RS, the UE 115-a can be preconfigured or requested to report beam information for each respective measurement, or may jointly report a unified beam information applied to all the measured L1-RSRPs/L1-SINRs addressed in the same feedback message. For example, the UE 115-a may have used a level-1 beam for measuring L1-RSRP for SSB #1, while the UE 115-b may alternatively have used level-2 beam for measuring L1-RSRP for SSB #2. Examples of level-1 and level-2 beams are discussed in more detail with reference to the examples of FIG. 3. In another example, the UE 115-a may have been requested (e.g., via a CSI report setting configuration, or MAC-CE activating a semi-persistent CSI report, or RRC configuration of CSI-AssocitedReportConfigInfo of an aperiodic CSI report) to always measure all L1-RSRPs with respect to a single CSI report, based on the same antenna panel, and thus the UE 115-a only needs to report a single Panel-ID per CSI report. Alternatively, the network entity 105-a may relax such restriction through the same signaling schemes, such that the UE 115-a reports respective Panel-IDs for each measured L1-RSRP/L1-SINR addressed in the CSI report.

In some cases, for CSI report-based UE L1-RSRP/L1-SINR feedback, if the total number of receive beam information items is also reported by the CSI report, 2-Part CSI reporting may be used, where the UE 115-a first reports a total number of candidate beam information items in CSI Part-1 via a fixed payload, and further reports detailed beam information identifiers in CSI Part-2 with a payload size identified based on CSI Part-1. In some cases, if the total amount of candidate beam information is predefined, or configured/indicated, or UE pre-reported as a capability, a one-Part CSI report may be used based on a fixed payload size.

In accordance with some aspects, the network entity 105-a may provide TCI state indication 235 based on the UE-side beam information, for joint/downlink or uplink TCI-States. In some cases, the network entity 105-a may indicate one or more of the UE-side beam information when configuring or activating or switching a joint/downlink or uplink TCI-state. In some cases, UE-side beam information can be RRC configured by a TCI-state RRC information element, or indicated when activating the TCI-state via MAC-CE, or dynamically indicated by the same downlink control information (DCI) when switching the TCI-state via DCI.

When indicating the level-ID of the UE-side beams associated with the TCI-state, the UE 115-a may determine its transmit/receive beam(s) associated with the TCI-state, following the level-ID indicated by the network entity 105-a (e.g., UL-transmit beams are assumed to be pair-wise associated with each respective receive beam). This may be further based on UE 115-a pre-reported candidate levels that are indicated via UE 115-a capability reporting; or may be further based on beam level-IDs (e.g., level-1 beam, level-2 beam) based on candidate level-IDs with respect to the most recently UE 115-a reported L1-RSRPs associated with the downlink reference signals in the TCI-state. In some case, when indicating a panel-ID of the UE-side beams associated with the TCI-state, the UE 115-a may determine its transmit/receive beam(s) associated with the TCI-state following the panel-ID indicated by the network entity 105-a (e.g., uplink transmit beams are assumed to be pair-wise associated with each respective receive beam). This may be further based on a UE 115-a pre-reported total number of panels (e.g., provided via UE capability reporting); or be further based on identify the panel-IDs based on candidate panel-IDs with respect to the most recently UE 115-a reported L1-RSRPs associated with the downlink reference signals in the TCI-state. For example, due to a high throughput requirement, the network entity 105-a may prefer the UE 115-a to use level-2 (narrow) beams to receive physical downlink shared channel (PDSCH) for a particular TCI-state. But, which specific receive beam should be used is up to UE implementation. By indicating the associated receive beam information with the TCI state, the UE 115-a may identify which UE-side beam is most preferable for the subsequent communications.

As discussed, in some aspects the UE 115-a may provide a capability indication 215 to the network entity 105-a that provides its capabilities related to reporting receive beam information, supporting TCI state indications that indicate a UE-side beam, or both. In some cases, the UE 115-a may report its capability of supporting all or certain subset of the beam information reporting, for indication from the network entity 105-a associated with TCI-states, for reporting such bean information associated with measurements in measurement report 230, or any combinations thereof. In some cases, such UE 115-a capability can be jointly or separately applied to the TCI state indication 235 and UE L1 measurement report 230. In cases where the capability is jointly applied, UE 115-a reporting of support of certain beam information types may indicate support for both reporting such beam information in measurement report 230, as well as being indicated with such beam information regarding TCI-states. In cases where the capability is separately applied, the UE 115-a may indicate that it supports certain beam information type for reporting beam information in its measurement report 230, but report not supporting being indicated with such beam information regarding TCI-states. Similarly, such UE 115-a capability can be jointly or separately applied to joint, downlink, or uplink TCI-states, for indicating a certain types of beam information for a TCI-state.

FIG. 3 shows an example of a wireless communications 300 system with beam levels that support techniques for receive beam reporting for wireless communications in accordance with one or more aspects of the present disclosure. In some examples, the wireless communications system 300 may implement aspects of a wireless communications system 100 or 200. For example, the wireless communications system 300 may include a network entity 105-b and a UE 115-b which may be examples of corresponding devices as described with reference to FIGS. 1 and 2.

In some examples, the network entity 105-b may transmit communications to the UE 115-b via transmit beams 305, which may include a first transmit beam 305-a (e.g., associated with a first SSB or first CSI-RS), a second transmit beam 305-b (e.g., associated with a second SSB or second CSI-RS), and a third transmit beam 305-c (e.g., associated with a third SSB or third CSI-RS). The UE 115-b may receive communications using a relatively wide level-1 receive beam 310, or relatively narrow level-2 receive beams 315 (e.g., using a first level-2 receive beam 315-a, a second level-2 receive beam 315-b, a third level-2 receive beam 315-c, or a fourth level-2 receive beam 315-d). Further, each of the level-1 receive beam 310 and the level-2 receive beams 315 may have an associated beam width, and an associated array gain. In cases where the UE 115-b measures one or more CMRs suing a level-2 receive beam 315, the UE 115-b may only report that the receive beam 315 is a level-2 beam, but not report the specific beam identification (e.g., a specific beam-ID of second level-2 receive beam 315-b when it is used for measuring the CMR). In the event that the UE 115-b is indicated with a TCI state that indicates a level-2 receive beam 315, the UE 115-b may identify the particular beam based on which beams were used for the measurement report.

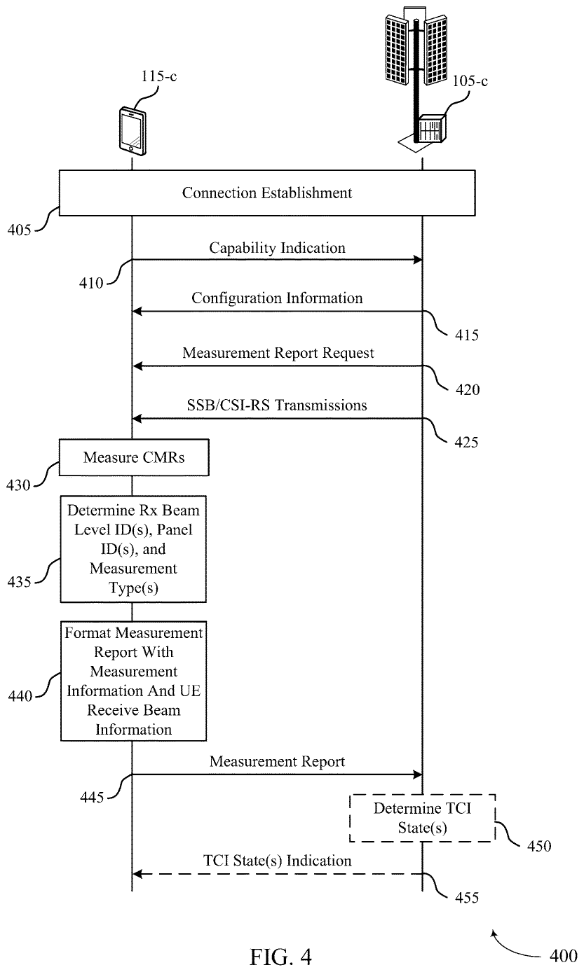

FIG. 4 shows an example of a process flow 400 that supports techniques for receive beam reporting for wireless communications in accordance with one or more aspects of the present disclosure. In some examples, the process flow 400 may be implemented by aspects of a wireless communications system 100, 200, or 300. For example, the process flow 400 may be implemented by a UE 115-c and a network entity 105-c, and which may be examples of UEs and network entities as described with reference to FIG. 1-3. Alternative examples of the following may be implemented, where some steps are performed in a different order than described or are not performed at all. In some cases, steps may include additional features not mentioned below, or furth steps may be added.

At 405, the UE 115-c and the network entity 105-c may perform a connection establishment procedure. Such a connection establishment may be performed in accordance with established network access techniques. At 410, the UE 115-c may transmit, and the network entity 105-c may receive, a capability indication to the network entity 105-c. In some case, the capability indication may provide UE 115-c capabilities to report UE-side beam information along with measurements in a measurement report. Further, in some cases, the capability indication may provide UE 115-c capabilities to receive TCI state indications that are based on reported beam information.

At 415, the network entity 105-c may transmit, and the UE 115-c may receive, configuration information. The configuration information may include, for example, configuration parameters for UE-side beam information reporting as discussed herein, such as a number of beam level indications (e.g., omni, wide, narrow), a number of array gain level indications (e.g., low or high gain), a number of antenna panels, measurement types to be reported, or any combinations thereof. At 420, the network entity 105-c may transmit, and the UE 115-c may receive, a measurement report request, that triggers the UE 115-c to transmit a measurement report. In some cases, the measurement report request may include an indication that UE receive beam information is to be provided with the measurement report (e.g., based on a CSI report configuration, other configuration data, a DCI indication, etc.). At 425, the network entity 105-c may transmit one or more reference signals (e.g., SSB/CSI-RS transmissions) for measurement at the UE 115-c.

At 430, the UE 115-c may measure one or more CMRs using one or more receive beams, in accordance with techniques discussed herein. At 435, the UE 115-c may determine one or more receive beam levels, panel IDs, and measurement types, associated with the measured CMRs. The receive beam levels, panel IDs, and measurement types are discussed in more detail with reference to the examples of FIGS. 2 and 3.

At 440, the UE 115-c may format a measurement report with measurement information and UE receive beam information, in accordance with techniques as discussed herein. At 445, the UE 115-c may transmit, and the network entity 105-c may receive, the measurement report.

Optionally, at 450, the network entity 105-c may determine one or more TCI states for one or more upcoming communications periods based at least in part on the measurement report and the reported beam information. In such cases, at 455, the network entity 105-c may transmit, and the UE 115-c may receive, a TCI state indication that may indicate a TCI state for the UE 115-c.

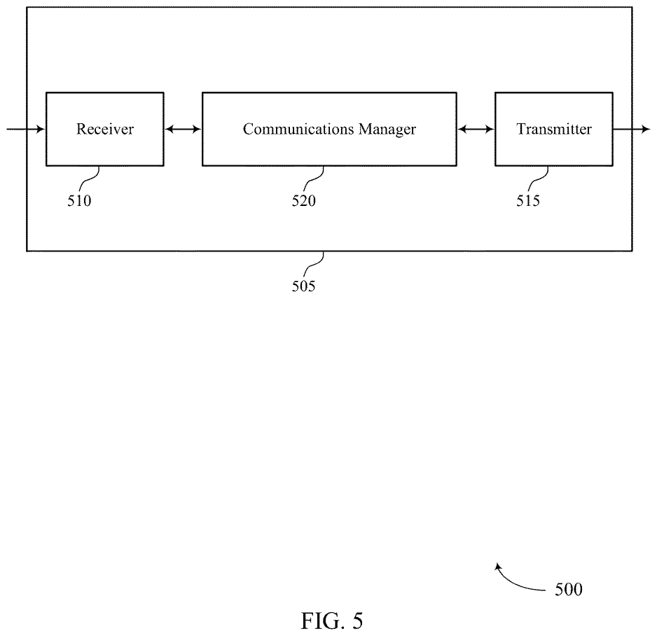

FIG. 5 shows a block diagram 500 of a device 505 that supports techniques for receive beam reporting for wireless communications in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for receive beam reporting for wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for receive beam reporting for wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for receive beam reporting for wireless communications as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving a request for a beam report for a set of channel measurement resources, the request including a UE beam information request for one or more receive beams used for one or more measurements of at least a subset of the set of channel measurement resources. The communications manager 520 is capable of, configured to, or operable to support a means for measuring each measurement resource of the set of channel measurement resources using one or more receive beams. The communications manager 520 is capable of, configured to, or operable to support a means for transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for UE receive beam information reporting, which may be used at a network entity to determine one or more TCI states for communications that may enhance communications efficiency and reliability.

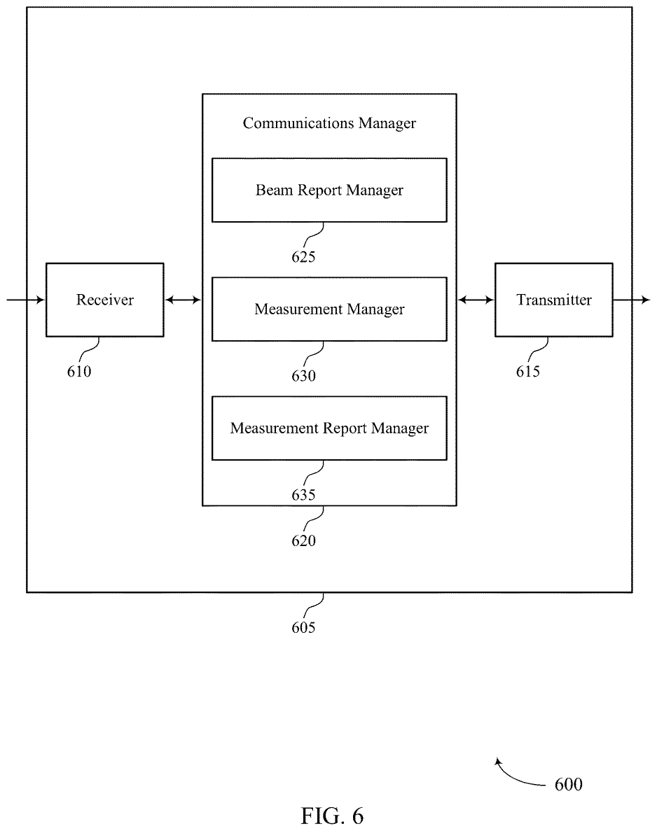

FIG. 6 shows a block diagram 600 of a device 605 that supports techniques for receive beam reporting for wireless communications in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for receive beam reporting for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for receive beam reporting for wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for receive beam reporting for wireless communications as described herein. For example, the communications manager 620 may include a beam report manager 625, a measurement manager 630, a measurement report manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The beam report manager 625 is capable of, configured to, or operable to support a means for receiving a request for a beam report for a set of channel measurement resources, the request including a UE beam information request for one or more receive beams used for one or more measurements of at least a subset of the set of channel measurement resources. The measurement manager 630 is capable of, configured to, or operable to support a means for measuring each measurement resource of the set of channel measurement resources using one or more receive beams. The measurement report manager 635 is capable of, configured to, or operable to support a means for transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

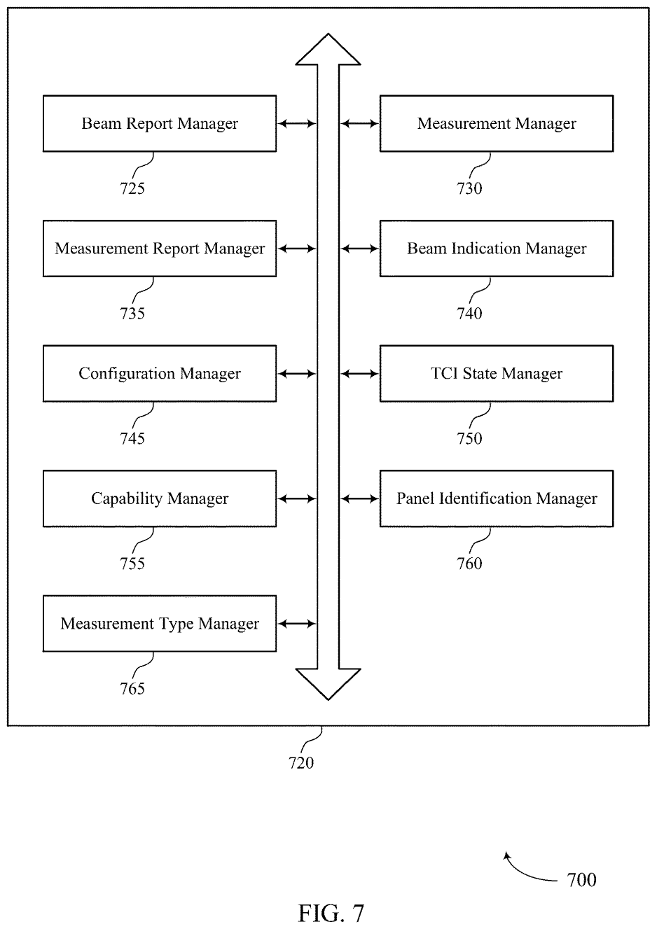

FIG. 7 shows a block diagram 700 of a communications manager 720 that supports techniques for receive beam reporting for wireless communications in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for receive beam reporting for wireless communications as described herein. For example, the communications manager 720 may include a beam report manager 725, a measurement manager 730, a measurement report manager 735, a beam indication manager 740, a configuration manager 745, a TCI state manager 750, a capability manager 755, a panel identification manager 760, a measurement type manager 765, or any combination thereof. Each of these components, or components or subcomponents thereof (e.g., one or more processors, one or more memories), may communicate, directly or indirectly, with one another (e.g., via one or more buses).

The communications manager 720 may support wireless communications at a UE in accordance with examples as disclosed herein. The beam report manager 725 is capable of, configured to, or operable to support a means for receiving a request for a beam report for a set of channel measurement resources, the request including a UE beam information request for one or more receive beams used for one or more measurements of at least a subset of the set of channel measurement resources. The measurement manager 730 is capable of, configured to, or operable to support a means for measuring each measurement resource of the set of channel measurement resources using one or more receive beams. The measurement report manager 735 is capable of, configured to, or operable to support a means for transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

In some examples, the beam level indication indicates one or more of a beam width of the receive beam or an array gain of the receive beam, where the beam width is indicated based on two or more beam width thresholds, and the array gain is indicated based on two or more array gain thresholds. In some examples, the measurement report further includes one or more of an antenna panel identification of the receive beam, a measurement type of the receive beam, or any combinations thereof. In some examples, the antenna panel identification indicates one or more antenna panels used at the UE for the receive beam. In some examples, the measurement type indicates a first measurement type associated with two or more receive beams is associated with the corresponding measurement, or a second measurement type that indicates a single receive beam is associated with the corresponding measurement.

In some examples, the beam indication manager 740 is capable of, configured to, or operable to support a means for identifying one or more candidate beam level indications for one or more receive beams used for the one or more corresponding measurements of at least the subset of the set of channel measurement resources, the candidate beam level indications based on one or more predefined threshold beam widths, one or more configured beam levels and associated beam widths, or one or more UE-selected beam levels and associated beam widths. In some examples, the beam indication manager 740 is capable of, configured to, or operable to support a means for determining which of the one or more candidate beam level indications to provide with one or more measurements of the measurement report based on the beam width of the receive beam associated with the one or more measurements.

In some examples, the measurement report manager 735 is capable of, configured to, or operable to support a means for transmitting one or more of an indication of a total quantity of antenna panels at the UE, or an indication of one or more measurement types that can be reported by the UE.

In some examples, the configuration manager 745 is capable of, configured to, or operable to support a means for receiving configuration information for one or more receive beam parameters to be reported with the measurement report during an initial access procedure. In some examples, the configuration manager 745 is capable of, configured to, or operable to support a means for receiving configuration information for one or more receive beam parameters to be reported with the measurement report as part of a channel state information report configuration.

In some examples, the measurement report includes one or more fields for the beam level indication and the beam identification of the receive beam, the one or more fields being predefined fields or network configured fields, where the one or more fields are each associated with a single channel measurement resource or are associated with all of the channel measurement resources of at least the subset of the set of channel measurement resources. In some examples, the measurement report is provided with a CSI part-1 report, with a CSI part-2 report, or any combinations thereof.

In some examples, the TCI state manager 750 is capable of, configured to, or operable to support a means for receiving an indication of a TCI state for one or more subsequent communications, the TCI state indicating a joint TCI state associated with a transmit beam from a network entity and a receive beam at the UE. In some examples, the receive beam at the UE is indicated by one or more of a beam level indication or an antenna panel identification, and the UE determines the indicated receive beam based on one or more reported beam level indications or antenna panel identifications provided in one or more measurement reports.

In some examples, the capability manager 755 is capable of, configured to, or operable to support a means for transmitting UE capability information that indicates a UE capability related to receive beam reporting associated with measurements in a measurement report. In some examples, the UE capability information further indicates a UE capability to receive an indication of a transmission configuration indicator state for UE receive beams for one or more subsequent communications.

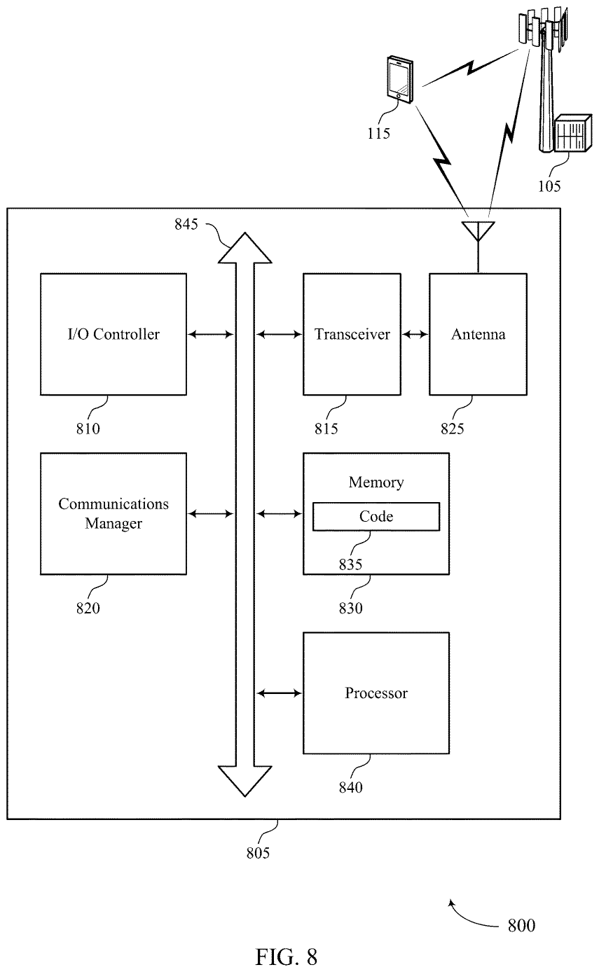

FIG. 8 shows a diagram of a system 800 including a device 805 that supports techniques for receive beam reporting for wireless communications in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for receive beam reporting for wireless communications). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein.

The communications manager 820 may support wireless communications at a UE in accordance with examples as disclosed herein. For example, the communications manager 820 is capable of, configured to, or operable to support a means for receiving a request for a beam report for a set of channel measurement resources, the request including a UE beam information request for one or more receive beams used for one or more measurements of at least a subset of the set of channel measurement resources. The communications manager 820 is capable of, configured to, or operable to support a means for measuring each measurement resource of the set of channel measurement resources using one or more receive beams. The communications manager 820 is capable of, configured to, or operable to support a means for transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

By including or configuring the communications manager 820 in accordance with examples as described herein, the device 805 may support techniques for UE receive beam information reporting, which may be used at a network entity to determine one or more TCI states for communications that may enhance communications efficiency and reliability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for receive beam reporting for wireless communications as described herein, or the at least one processor 840 and the at least one memory 830 may be otherwise configured to, individually or collectively, perform or support such operations.

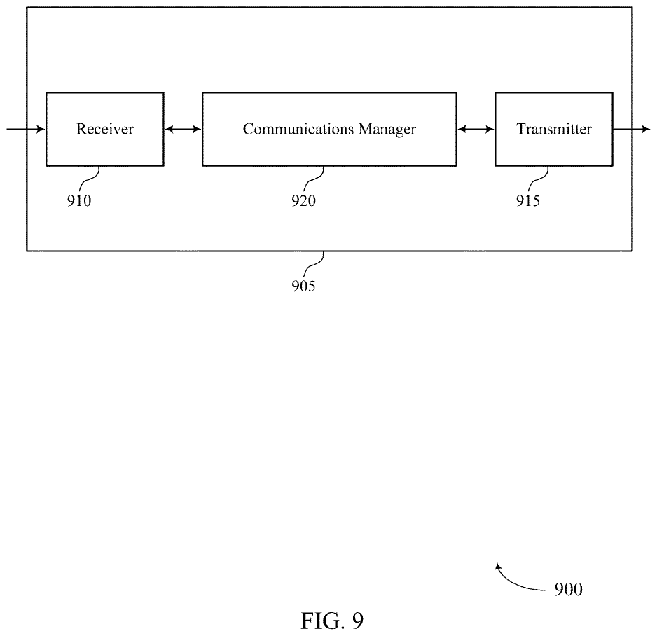

FIG. 9 shows a block diagram 900 of a device 905 that supports techniques for receive beam reporting for wireless communications in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for receive beam reporting for wireless communications as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for transmitting, to a UE, a request for a beam report for a set of channel measurement resources, the request including a UE beam information request for one or more receive beams used at the UE for one or more measurements of at least a subset of the set of channel measurement resources. The communications manager 920 is capable of, configured to, or operable to support a means for receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for UE receive beam information reporting, which may be used at a network entity to determine one or more TCI states for communications that may enhance communications efficiency and reliability.

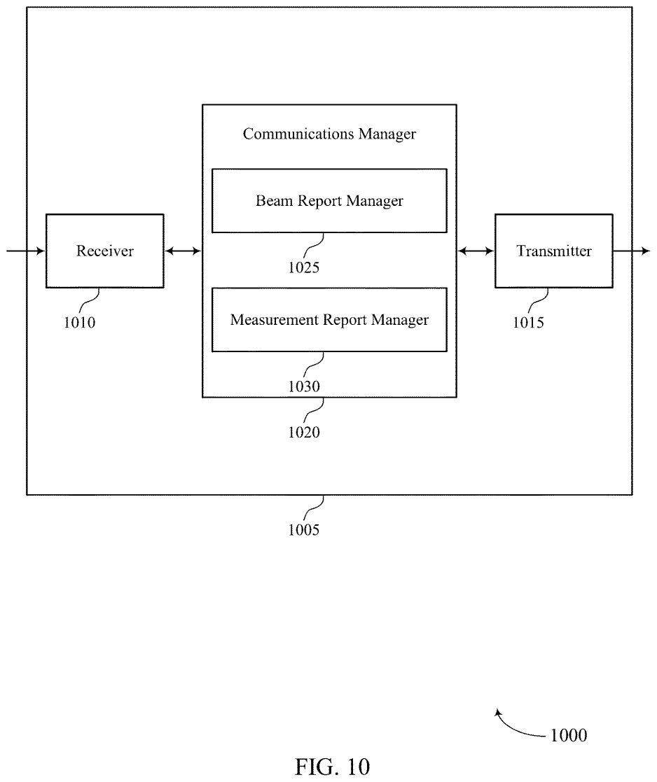

FIG. 10 shows a block diagram 1000 of a device 1005 that supports techniques for receive beam reporting for wireless communications in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for receive beam reporting for wireless communications as described herein. For example, the communications manager 1020 may include a beam report manager 1025 a measurement report manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The beam report manager 1025 is capable of, configured to, or operable to support a means for transmitting, to a UE, a request for a beam report for a set of channel measurement resources, the request including a UE beam information request for one or more receive beams used at the UE for one or more measurements of at least a subset of the set of channel measurement resources. The measurement report manager 1030 is capable of, configured to, or operable to support a means for receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

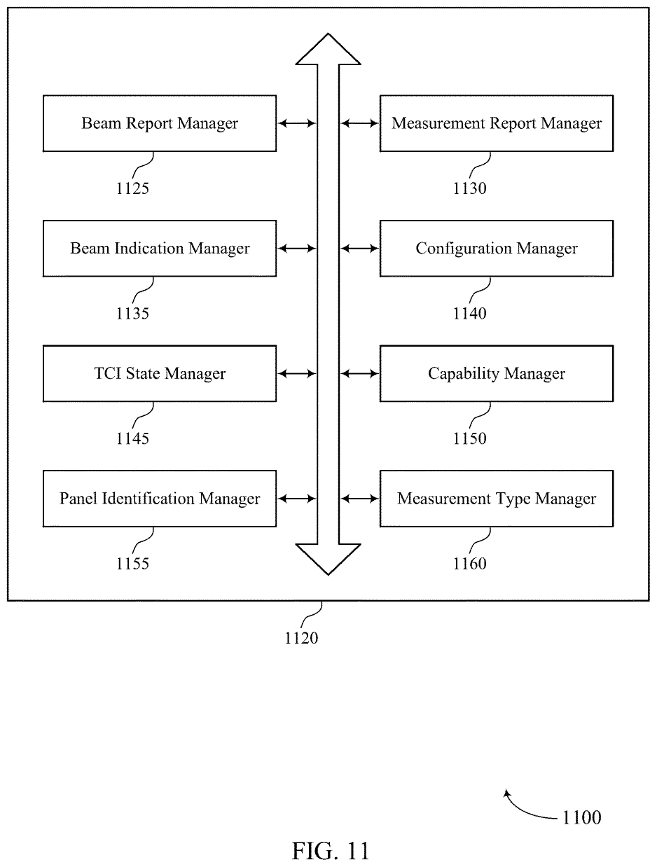

FIG. 11 shows a block diagram 1100 of a communications manager 1120 that supports techniques for receive beam reporting for wireless communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for receive beam reporting for wireless communications as described herein. For example, the communications manager 1120 may include a beam report manager 1125, a measurement report manager 1130, a beam indication manager 1135, a configuration manager 1140, a TCI state manager 1145, a capability manager 1150, a panel identification manager 1155, a measurement type manager 1160, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The beam report manager 1125 is capable of, configured to, or operable to support a means for transmitting, to a UE, a request for a beam report for a set of channel measurement resources, the request including a UE beam information request for one or more receive beams used at the UE for one or more measurements of at least a subset of the set of channel measurement resources. The measurement report manager 1130 is capable of, configured to, or operable to support a means for receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

In some examples, the beam level indication indicates one or more of a beam width of the receive beam or an array gain of the receive beam, where the beam width is indicated based on two or more beam width thresholds, and the array gain is indicated based on two or more array gain thresholds. In some examples, the measurement report further includes one or more of an antenna panel identification of the receive beam, a measurement type of the receive beam, or any combinations thereof. In some examples, the antenna panel identification indicates one or more antenna panels used at the UE for the receive beam. In some examples, the measurement type indicates a first measurement type associated with two or more receive beams is associated with the corresponding measurement, or a second measurement type that indicates a single receive beam is associated with the corresponding measurement.

In some examples, the beam indication manager 1135 is capable of, configured to, or operable to support a means for identifying one or more candidate beam level indications for one or more receive beams used for the one or more corresponding measurements of at least the subset of the set of channel measurement resources, the candidate beam level indications based on one or more predefined threshold beam widths, one or more configured beam levels and associated beam widths, or one or more UE-selected beam levels and associated beam widths. In some examples, the beam indication manager 1135 is capable of, configured to, or operable to support a means for determining a beam width of each receive beam used at the UE for the one or more corresponding measurements for at least the subset of the set of channel measurement resources based on the one or more candidate beam level indications.

In some examples, the configuration manager 1140 is capable of, configured to, or operable to support a means for transmitting configuration information for one or more receive beam parameters to be reported with the measurement report during an initial access procedure. In some examples, the TCI state manager 1145 is capable of, configured to, or operable to support a means for receiving an indication of a TCI state for one or more subsequent communications, the TCI state indicating a joint TCI state associated with a transmit beam from a network entity and the receive beam at the UE. In some examples, the capability manager 1150 is capable of, configured to, or operable to support a means for receiving UE capability information that indicates a UE capability related to receive beam reporting associated with measurements in a measurement report.

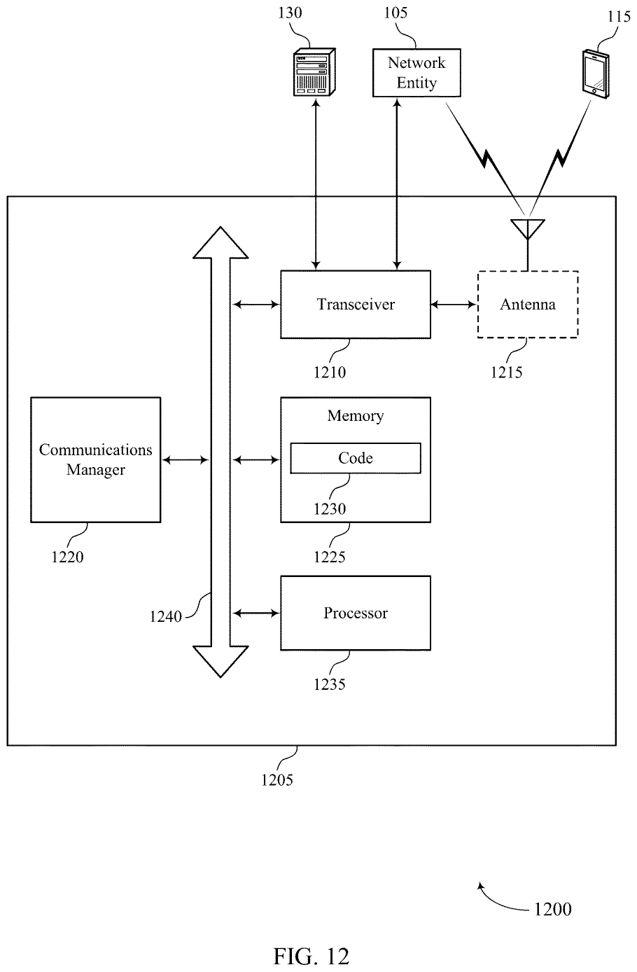

FIG. 12 shows a diagram of a system 1200 including a device 1205 that supports techniques for receive beam reporting for wireless communications in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for receive beam reporting for wireless communications). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some implementations, the at least one processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the at least one processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for transmitting, to a UE, a request for a beam report for a set of channel measurement resources, the request including a UE beam information request for one or more receive beams used at the UE for one or more measurements of at least a subset of the set of channel measurement resources. The communications manager 1220 is capable of, configured to, or operable to support a means for receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

By including or configuring the communications manager 1220 in accordance with examples as described herein, the device 1205 may support techniques for UE receive beam information reporting, which may be used at a network entity to determine one or more TCI states for communications that may enhance communications efficiency and reliability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for receive beam reporting for wireless communications as described herein, or the at least one processor 1235 and the at least one memory 1225 may be otherwise configured to, individually or collectively, perform or support such operations.

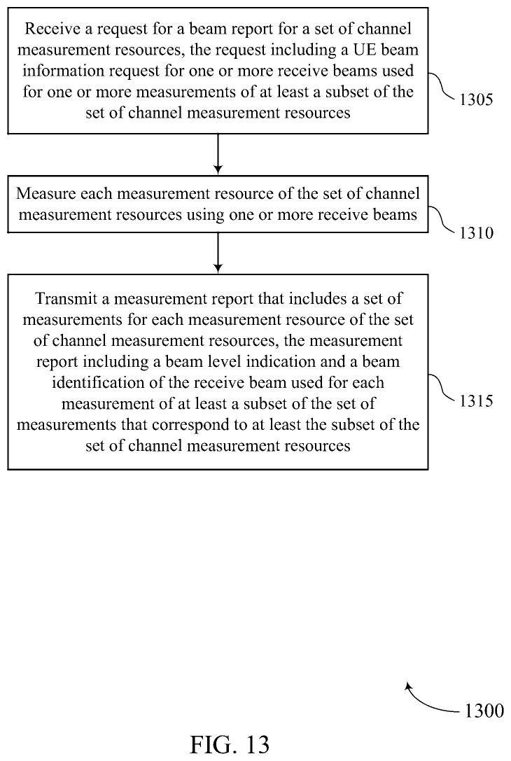

FIG. 13 shows a flowchart illustrating a method 1300 that supports techniques for receive beam reporting for wireless communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a request for a beam report for a set of channel measurement resources, the request including a UE beam information request for one or more receive beams used for one or more measurements of at least a subset of the set of channel measurement resources. The operations of block 1305 may be performed in accordance with examples as disclosed herein. In some examples, aspects of the operations of 1305 may be performed by a beam report manager 725 as described with reference to FIG. 7.

At 1310, the method may include measuring each measurement resource of the set of channel measurement resources using one or more receive beams. The operations of block 1310 may be performed in accordance with examples as disclosed herein. In some examples, aspects of the operations of 1310 may be performed by a measurement manager 730 as described with reference to FIG. 7.

At 1315, the method may include transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources. The operations of block 1315 may be performed in accordance with examples as disclosed herein. In some examples, aspects of the operations of 1315 may be performed by a measurement report manager 735 as described with reference to FIG. 7.

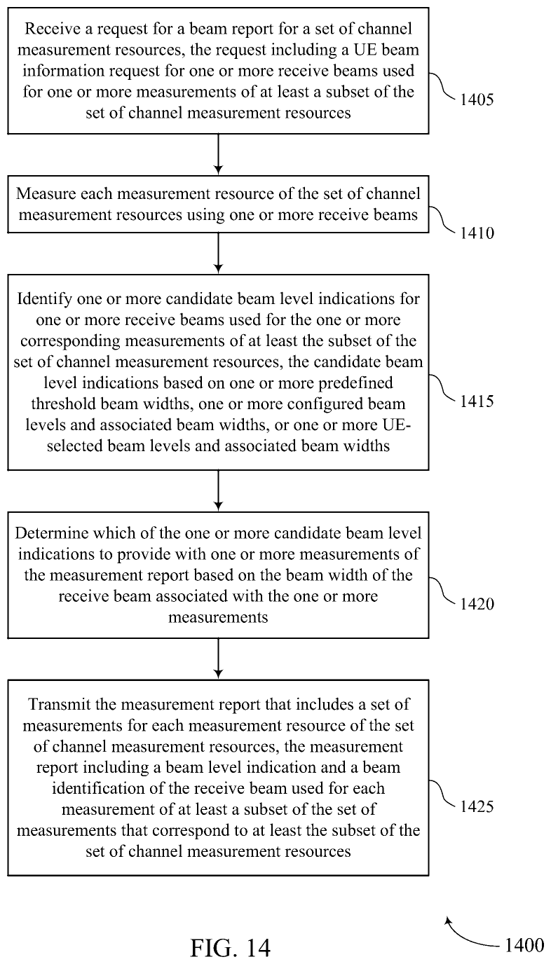

FIG. 14 shows a flowchart illustrating a method 1400 that supports techniques for receive beam reporting for wireless communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a request for a beam report for a set of channel measurement resources, the request including a UE beam information request for one or more receive beams used for one or more measurements of at least a subset of the set of channel measurement resources. The operations of block 1405 may be performed in accordance with examples as disclosed herein. In some examples, aspects of the operations of 1405 may be performed by a beam report manager 725 as described with reference to FIG. 7.

At 1410, the method may include measuring each measurement resource of the set of channel measurement resources using one or more receive beams. The operations of block 1410 may be performed in accordance with examples as disclosed herein. In some examples, aspects of the operations of 1410 may be performed by a measurement manager 730 as described with reference to FIG. 7.

At 1415, the method may include identifying one or more candidate beam level indications for one or more receive beams used for the one or more corresponding measurements of at least the subset of the set of channel measurement resources, the candidate beam level indications based on one or more predefined threshold beam widths, one or more configured beam levels and associated beam widths, or one or more UE-selected beam levels and associated beam widths. The operations of block 1415 may be performed in accordance with examples as disclosed herein. In some examples, aspects of the operations of 1415 may be performed by a beam indication manager 740 as described with reference to FIG. 7.

At 1420, the method may include determining which of the one or more candidate beam level indications to provide with one or more measurements of the measurement report based on the beam width of the receive beam associated with the one or more measurements. The operations of block 1420 may be performed in accordance with examples as disclosed herein. In some examples, aspects of the operations of 1420 may be performed by a beam indication manager 740 as described with reference to FIG. 7.

At 1425, the method may include transmitting the measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources. The operations of block 1425 may be performed in accordance with examples as disclosed herein. In some examples, aspects of the operations of 1425 may be performed by a measurement report manager 735 as described with reference to FIG. 7.

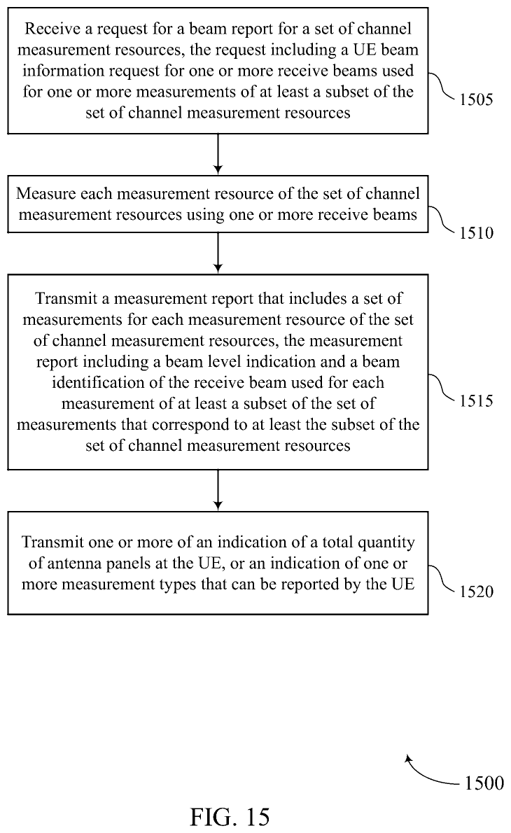

FIG. 15 shows a flowchart illustrating a method 1500 that supports techniques for receive beam reporting for wireless communications in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a request for a beam report for a set of channel measurement resources, the request including a UE beam information request for one or more receive beams used for one or more measurements of at least a subset of the set of channel measurement resources. The operations of block 1505 may be performed in accordance with examples as disclosed herein. In some examples, aspects of the operations of 1505 may be performed by a beam report manager 725 as described with reference to FIG. 7.

At 1510, the method may include measuring each measurement resource of the set of channel measurement resources using one or more receive beams. The operations of block 1510 may be performed in accordance with examples as disclosed herein. In some examples, aspects of the operations of 1510 may be performed by a measurement manager 730 as described with reference to FIG. 7.

At 1515, the method may include transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources. The operations of block 1515 may be performed in accordance with examples as disclosed herein. In some examples, aspects of the operations of 1515 may be performed by a measurement report manager 735 as described with reference to FIG. 7.

At 1520, the method may include transmitting one or more of an indication of a total quantity of antenna panels at the UE, or an indication of one or more measurement types that can be reported by the UE. The operations of block 1520 may be performed in accordance with examples as disclosed herein. In some examples, aspects of the operations of 1520 may be performed by a measurement report manager 735 as described with reference to FIG. 7.

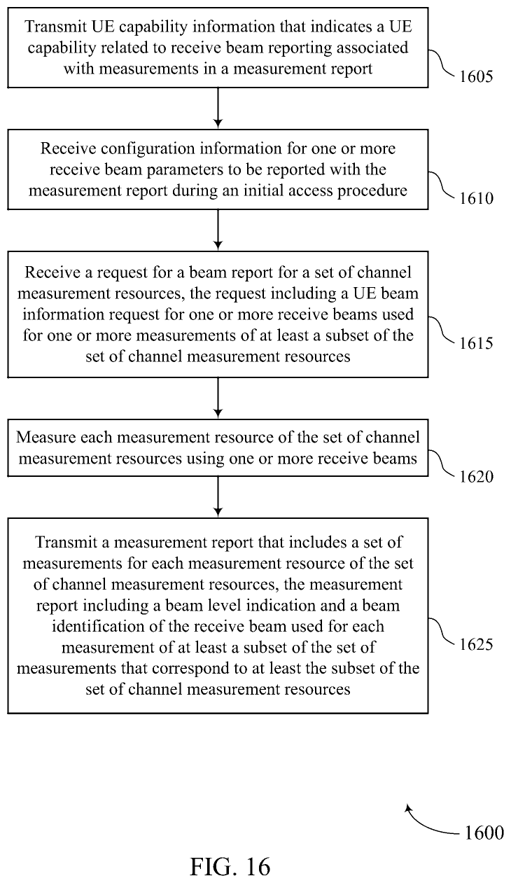

FIG. 16 shows a flowchart illustrating a method 1600 that supports techniques for receive beam reporting for wireless communications in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1605, the method may include transmitting UE capability information that indicates a UE capability related to receive beam reporting associated with measurements in a measurement report. The operations of block 1605 may be performed in accordance with examples as disclosed herein. In some examples, aspects of the operations of 1605 may be performed by a capability manager 755 as described with reference to FIG. 7.

At 1610, the method may include receiving configuration information for one or more receive beam parameters to be reported with the measurement report during an initial access procedure. The operations of block 1610 may be performed in accordance with examples as disclosed herein. In some examples, aspects of the operations of 1610 may be performed by a configuration manager 745 as described with reference to FIG. 7.

At 1615, the method may include receiving a request for a beam report for a set of channel measurement resources, the request including a UE beam information request for one or more receive beams used for one or more measurements of at least a subset of the set of channel measurement resources. The operations of block 1615 may be performed in accordance with examples as disclosed herein. In some examples, aspects of the operations of 1615 may be performed by a beam report manager 725 as described with reference to FIG. 7.

At 1620, the method may include measuring each measurement resource of the set of channel measurement resources using one or more receive beams. The operations of block 1620 may be performed in accordance with examples as disclosed herein. In some examples, aspects of the operations of 1620 may be performed by a measurement manager 730 as described with reference to FIG. 7.

At 1625, the method may include transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources. The operations of block 1625 may be performed in accordance with examples as disclosed herein. In some examples, aspects of the operations of 1625 may be performed by a measurement report manager 735 as described with reference to FIG. 7.

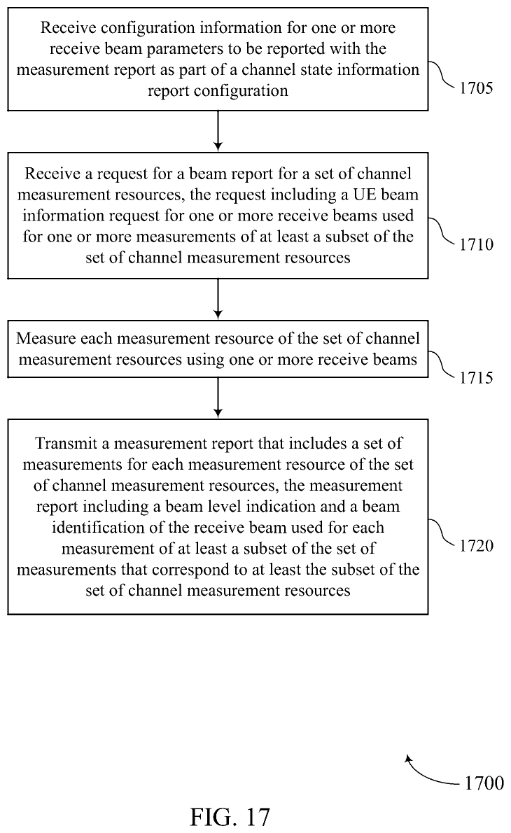

FIG. 17 shows a flowchart illustrating a method 1700 that supports techniques for receive beam reporting for wireless communications in accordance with aspects of the present disclosure. The operations of the method 1700 may be implemented by a UE or its components as described herein. For example, the operations of the method 1700 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1705, the method may include receiving configuration information for one or more receive beam parameters to be reported with the measurement report as part of a channel state information report configuration. The operations of block 1705 may be performed in accordance with examples as disclosed herein. In some examples, aspects of the operations of 1705 may be performed by a configuration manager 745 as described with reference to FIG. 7.

At 1710, the method may include receiving a request for a beam report for a set of channel measurement resources, the request including a UE beam information request for one or more receive beams used for one or more measurements of at least a subset of the set of channel measurement resources. The operations of block 1710 may be performed in accordance with examples as disclosed herein. In some examples, aspects of the operations of 1710 may be performed by a beam report manager 725 as described with reference to FIG. 7.

At 1715, the method may include measuring each measurement resource of the set of channel measurement resources using one or more receive beams. The operations of block 1715 may be performed in accordance with examples as disclosed herein. In some examples, aspects of the operations of 1715 may be performed by a measurement manager 730 as described with reference to FIG. 7.

At 1720, the method may include transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources. The operations of block 1720 may be performed in accordance with examples as disclosed herein. In some examples, aspects of the operations of 1720 may be performed by a measurement report manager 735 as described with reference to FIG. 7.

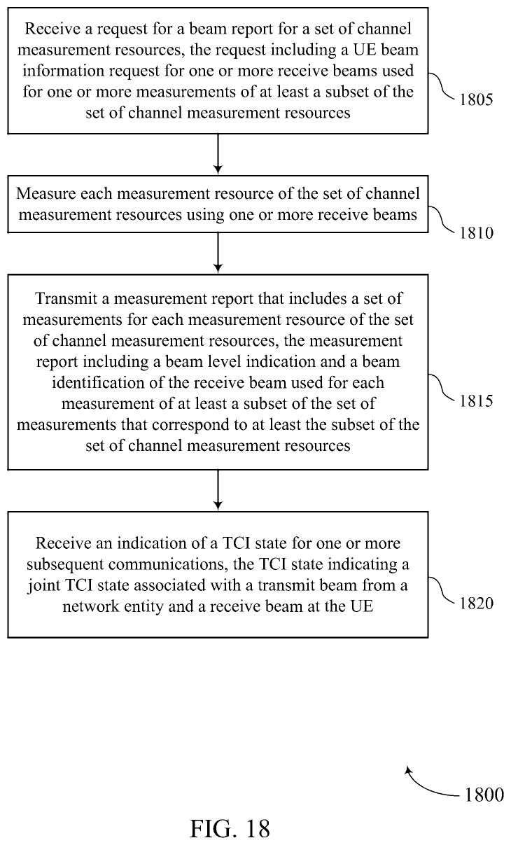

FIG. 18 shows a flowchart illustrating a method 1800 that supports techniques for receive beam reporting for wireless communications in accordance with aspects of the present disclosure. The operations of the method 1800 may be implemented by a UE or its components as described herein. For example, the operations of the method 1800 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1805, the method may include receiving a request for a beam report for a set of channel measurement resources, the request including a UE beam information request for one or more receive beams used for one or more measurements of at least a subset of the set of channel measurement resources. The operations of block 1805 may be performed in accordance with examples as disclosed herein. In some examples, aspects of the operations of 1805 may be performed by a beam report manager 725 as described with reference to FIG. 7.

At 1810, the method may include measuring each measurement resource of the set of channel measurement resources using one or more receive beams. The operations of block 1810 may be performed in accordance with examples as disclosed herein. In some examples, aspects of the operations of 1810 may be performed by a measurement manager 730 as described with reference to FIG. 7.

At 1815, the method may include transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources. The operations of block 1815 may be performed in accordance with examples as disclosed herein. In some examples, aspects of the operations of 1815 may be performed by a measurement report manager 735 as described with reference to FIG. 7.

At 1820, the method may include receiving an indication of a TCI state for one or more subsequent communications, the TCI state indicating a joint TCI state associated with a transmit beam from a network entity and a receive beam at the UE. The operations of block 1820 may be performed in accordance with examples as disclosed herein. In some examples, aspects of the operations of 1820 may be performed by a TCI state manager 750 as described with reference to FIG. 7.

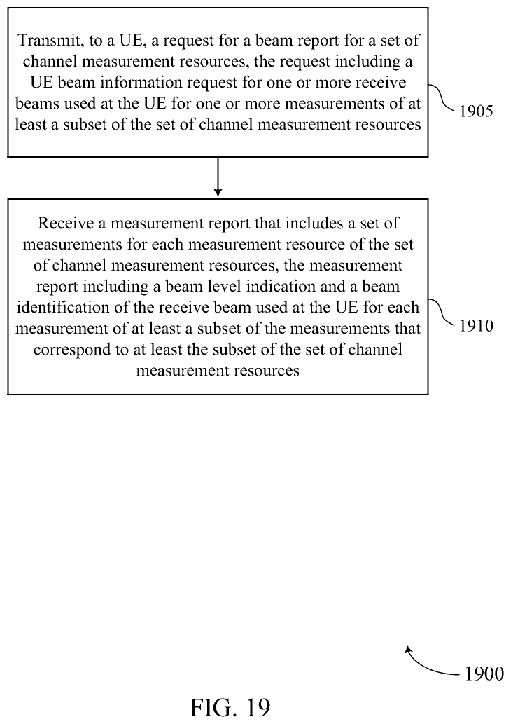

FIG. 19 shows a flowchart illustrating a method 1900 that supports techniques for receive beam reporting for wireless communications in accordance with aspects of the present disclosure. The operations of the method 1900 may be implemented by a network entity or its components as described herein. For example, the operations of the method 1900 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, a request for a beam report for a set of channel measurement resources, the request including a UE beam information request for one or more receive beams used at the UE for one or more measurements of at least a subset of the set of channel measurement resources. The operations of block 1905 may be performed in accordance with examples as disclosed herein. In some examples, aspects of the operations of 1905 may be performed by a beam report manager 1125 as described with reference to FIG. 11.

At 1910, the method may include receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources. The operations of block 1910 may be performed in accordance with examples as disclosed herein. In some examples, aspects of the operations of 1910 may be performed by a measurement report manager 1130 as described with reference to FIG. 11.

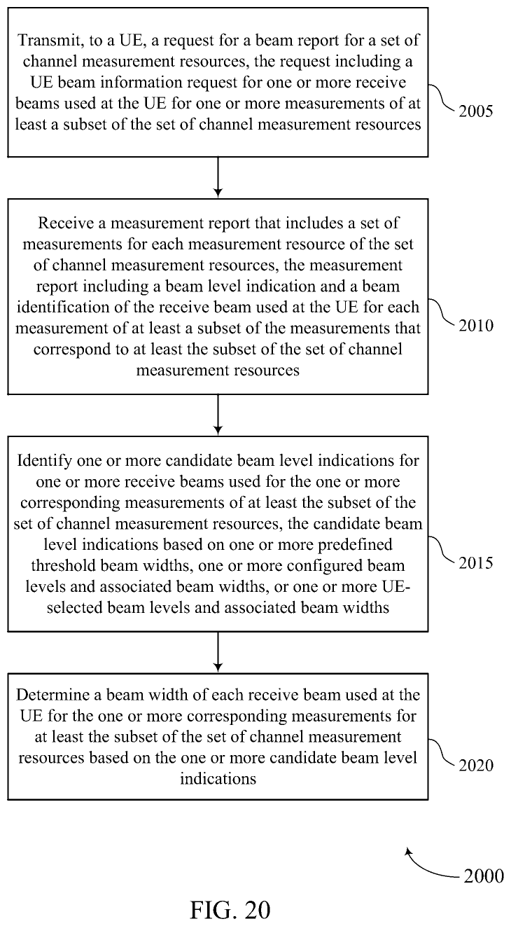

FIG. 20 shows a flowchart illustrating a method 2000 that supports techniques for receive beam reporting for wireless communications in accordance with aspects of the present disclosure. The operations of the method 2000 may be implemented by a network entity or its components as described herein. For example, the operations of the method 2000 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a UE, a request for a beam report for a set of channel measurement resources, the request including a UE beam information request for one or more receive beams used at the UE for one or more measurements of at least a subset of the set of channel measurement resources. The operations of block 2005 may be performed in accordance with examples as disclosed herein. In some examples, aspects of the operations of 2005 may be performed by a beam report manager 1125 as described with reference to FIG. 11.

At 2010, the method may include receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources. The operations of block 2010 may be performed in accordance with examples as disclosed herein. In some examples, aspects of the operations of 2010 may be performed by a measurement report manager 1130 as described with reference to FIG. 11.

At 2015, the method may include identifying one or more candidate beam level indications for one or more receive beams used for the one or more corresponding measurements of at least the subset of the set of channel measurement resources, the candidate beam level indications based on one or more predefined threshold beam widths, one or more configured beam levels and associated beam widths, or one or more UE-selected beam levels and associated beam widths. The operations of block 2015 may be performed in accordance with examples as disclosed herein. In some examples, aspects of the operations of 2015 may be performed by a beam indication manager 1135 as described with reference to FIG. 11.

At 2020, the method may include determining a beam width of each receive beam used at the UE for the one or more corresponding measurements for at least the subset of the set of channel measurement resources based on the one or more candidate beam level indications. The operations of block 2020 may be performed in accordance with examples as disclosed herein. In some examples, aspects of the operations of 2020 may be performed by a beam indication manager 1135 as described with reference to FIG. 11.

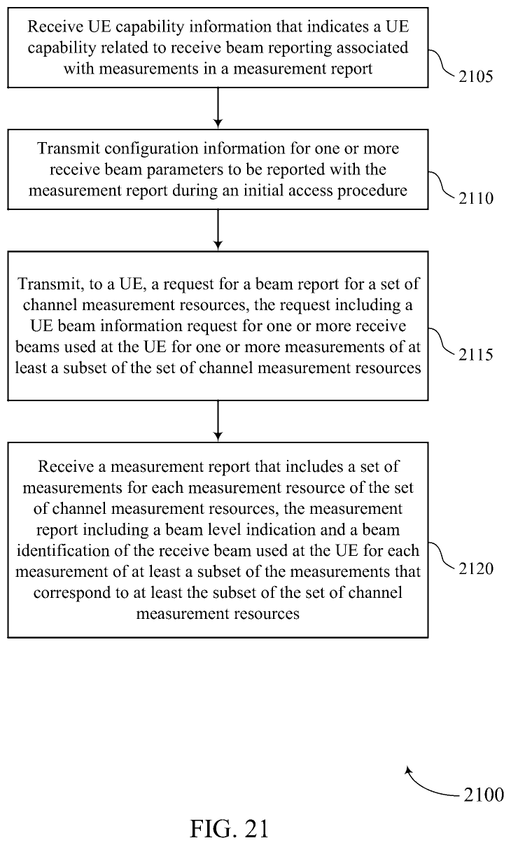

FIG. 21 shows a flowchart illustrating a method 2100 that supports techniques for receive beam reporting for wireless communications in accordance with aspects of the present disclosure. The operations of the method 2100 may be implemented by a network entity or its components as described herein. For example, the operations of the method 2100 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2105, the method may include receiving UE capability information that indicates a UE capability related to receive beam reporting associated with measurements in a measurement report. The operations of block 2105 may be performed in accordance with examples as disclosed herein. In some examples, aspects of the operations of 2105 may be performed by a capability manager 1150 as described with reference to FIG. 11.

At 2110, the method may include transmitting configuration information for one or more receive beam parameters to be reported with the measurement report during an initial access procedure. The operations of block 2110 may be performed in accordance with examples as disclosed herein. In some examples, aspects of the operations of 2110 may be performed by a configuration manager 1140 as described with reference to FIG. 11.

At 2115, the method may include transmitting, to a UE, a request for a beam report for a set of channel measurement resources, the request including a UE beam information request for one or more receive beams used at the UE for one or more measurements of at least a subset of the set of channel measurement resources. The operations of block 2115 may be performed in accordance with examples as disclosed herein. In some examples, aspects of the operations of 2115 may be performed by a beam report manager 1125 as described with reference to FIG. 11.

At 2120, the method may include receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources. The operations of block 2120 may be performed in accordance with examples as disclosed herein. In some examples, aspects of the operations of 2120 may be performed by a measurement report manager 1130 as described with reference to FIG. 11.

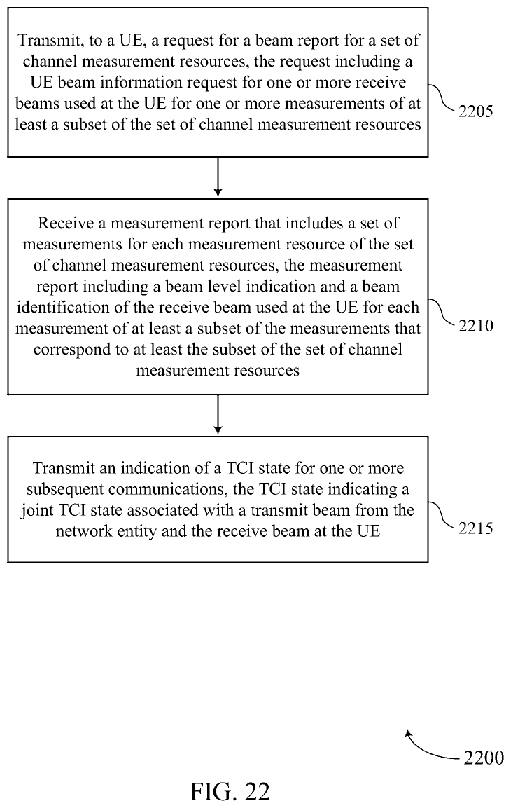

FIG. 22 shows a flowchart illustrating a method 2200 that supports techniques for receive beam reporting for wireless communications in accordance with aspects of the present disclosure. The operations of the method 2200 may be implemented by a network entity or its components as described herein. For example, the operations of the method 2200 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 2205, the method may include transmitting, to a UE, a request for a beam report for a set of channel measurement resources, the request including a UE beam information request for one or more receive beams used at the UE for one or more measurements of at least a subset of the set of channel measurement resources. The operations of block 2205 may be performed in accordance with examples as disclosed herein. In some examples, aspects of the operations of 2205 may be performed by a beam report manager 1125 as described with reference to FIG. 11.

At 2210, the method may include receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources. The operations of block 2210 may be performed in accordance with examples as disclosed herein. In some examples, aspects of the operations of 2210 may be performed by a measurement report manager 1130 as described with reference to FIG. 11.

At 2215, the method may include transmitting an indication of a TCI state for one or more subsequent communications, the TCI state indicating a joint TCI state associated with a transmit beam from the network entity and the receive beam at the UE. The operations of block 2215 may be performed in accordance with examples as disclosed herein. In some examples, aspects of the operations of 2215 may be performed by a TCI state manager 1145 as described with reference to FIG. 11.

The following provides an overview of aspects of the present disclosure:

Aspect 1: A method for wireless communications at a UE, comprising: receiving a request for a beam report for a set of channel measurement resources, the request including a UE beam information request for one or more receive beams used for one or more measurements of at least a subset of the set of channel measurement resources; measuring each measurement resource of the set of channel measurement resources using one or more receive beams; and transmitting a measurement report that includes a set of measurements for each measurement resource of the set of channel measurement resources, the measurement report including a beam level indication and a beam identification of the receive beam used for each measurement of at least a subset of the set of measurements that correspond to at least the subset of the set of channel measurement resources.

Aspect 2: The method of aspect 1, wherein the beam level indication indicates one or more of a beam width of the receive beam or an array gain of the receive beam, wherein the beam width is indicated based at least in part on two or more beam width thresholds, and the array gain is indicated based at least in part on two or more array gain thresholds.

Aspect 3: The method of any of aspects 1 through 2, wherein the measurement report further includes one or more of an antenna panel identification of the receive beam, a measurement type of the receive beam, or any combinations thereof.

Aspect 4: The method of aspect 3, wherein the antenna panel identification indicates one or more antenna panels used at the UE for the receive beam.

Aspect 5: The method of any of aspects 3 through 4, wherein the measurement type indicates a first measurement type associated with two or more receive beams is associated with the corresponding measurement, or a second measurement type that indicates a single receive beam is associated with the corresponding measurement.

Aspect 6: The method of any of aspects 1 through 5, further comprising: identifying one or more candidate beam level indications for one or more receive beams used for the one or more corresponding measurements of at least the subset of the set of channel measurement resources, the candidate beam level indications based at least in part on one or more predefined threshold beam widths, one or more configured beam levels and associated beam widths, or one or more UE-selected beam levels and associated beam widths; and determining which of the one or more candidate beam level indications to provide with one or more measurements of the measurement report based at least in part on the beam width of the receive beam associated with the one or more measurements.

Aspect 7: The method of any of aspects 1 through 6, further comprising: transmitting one or more of an indication of a total quantity of antenna panels at the UE, or an indication of one or more measurement types that can be reported by the UE.

Aspect 8: The method of any of aspects 1 through 7, further comprising: receiving configuration information for one or more receive beam parameters to be reported with the measurement report during an initial access procedure.

Aspect 9: The method of any of aspects 1 through 8, further comprising: receiving configuration information for one or more receive beam parameters to be reported with the measurement report as part of a channel state information report configuration.

Aspect 10: The method of any of aspects 1 through 9, wherein the measurement report includes one or more fields for the beam level indication and the beam identification of the receive beam, the one or more fields being predefined fields or network configured fields, wherein the one or more fields are each associated with a single channel measurement resource or are associated with all of the channel measurement resources of at least the subset of the set of channel measurement resources.

Aspect 11: The method of any of aspects 1 through 10, wherein the measurement report is provided with a CSI part-1 report, with a CSI part-2 report, or any combinations thereof.

Aspect 12: The method of any of aspects 1 through 11, further comprising: receiving an indication of a transmission configuration indicator (TCI) state for one or more subsequent communications, the TCI state indicating a joint TCI state associated with a transmit beam from a network entity and a receive beam at the UE.

Aspect 13: The method of aspect 12, wherein the receive beam at the UE is indicated by one or more of a beam level indication or an antenna panel identification, and the UE determines the indicated receive beam based on one or more reported beam level indications or antenna panel identifications provided in one or more measurement reports.

Aspect 14: The method of any of aspects 1 through 13, further comprising: transmitting UE capability information that indicates a UE capability related to receive beam reporting associated with measurements in a measurement report.

Aspect 15: The method of aspect 14, wherein the UE capability information further indicates a UE capability to receive an indication of a transmission configuration indicator state for UE receive beams for one or more subsequent communications.

Aspect 16: A method for wireless communications at a network entity, comprising: transmitting, to a UE, a request for a beam report for a set of channel measurement resources, the request including a UE beam information request for one or more receive beams used at the UE for one or more measurements of at least a subset of the set of channel measurement resources; and receiving a measurement report that includes a set of measurements for each measurement resource of the set of channel measurement resources, the measurement report including a beam level indication and a beam identification of the receive beam used at the UE for each measurement of at least a subset of the measurements that correspond to at least the subset of the set of channel measurement resources.

Aspect 17: The method of aspect 16, wherein the beam level indication indicates one or more of a beam width of the receive beam or an array gain of the receive beam, wherein the beam width is indicated based at least in part on two or more beam width thresholds, and the array gain is indicated based at least in part on two or more array gain thresholds.

Aspect 18: The method of any of aspects 16 through 17, wherein the measurement report further includes one or more of an antenna panel identification of the receive beam, a measurement type of the receive beam, or any combinations thereof.

Aspect 19: The method of aspect 18, wherein the antenna panel identification indicates one or more antenna panels used at the UE for the receive beam.

Aspect 20: The method of any of aspects 18 through 19, wherein the measurement type indicates a first measurement type associated with two or more receive beams is associated with the corresponding measurement, or a second measurement type that indicates a single receive beam is associated with the corresponding measurement.

Aspect 21: The method of any of aspects 16 through 20, further comprising: identifying one or more candidate beam level indications for one or more receive beams used for the one or more corresponding measurements of at least the subset of the set of channel measurement resources, the candidate beam level indications based at least in part on one or more predefined threshold beam widths, one or more configured beam levels and associated beam widths, or one or more UE-selected beam levels and associated beam widths; and determining a beam width of each receive beam used at the UE for the one or more corresponding measurements for at least the subset of the set of channel measurement resources based at least in part on the one or more candidate beam level indications.

Aspect 22: The method of any of aspects 16 through 21, further comprising: transmitting configuration information for one or more receive beam parameters to be reported with the measurement report during an initial access procedure.

Aspect 23: The method of any of aspects 16 through 22, further comprising: transmitting an indication of a transmission configuration indicator (TCI) state for one or more subsequent communications, the TCI state indicating a joint TCI state associated with a transmit beam from the network entity and the receive beam at the UE.

Aspect 24: The method of any of aspects 16 through 23, further comprising: receiving UE capability information that indicates a UE capability related to receive beam reporting associated with measurements in a measurement report.

Aspect 25: An apparatus for wireless communications at a UE, comprising at least one processor; at least one memory coupled with the at least one processor; and instructions stored in the at least one memory and executable by the at least one processor to cause the apparatus to perform a method of any of aspects 1 through 15.

Aspect 26: An apparatus for wireless communications at a UE, comprising at least one means for performing a method of any of aspects 1 through 15.

Aspect 27: A non-transitory computer-readable medium storing code for wireless communications at a UE, the code comprising instructions executable by a processor to perform a method of any of aspects 1 through 15.

Aspect 28: An apparatus for wireless communications at a network entity, comprising at least one processor; at least one memory coupled with the at least one processor; and instructions stored in the at least one memory and executable by the at least one processor to cause the apparatus to perform a method of any of aspects 16 through 24.

Aspect 29: An apparatus for wireless communications at a network entity, comprising at least one means for performing a method of any of aspects 16 through 24.

Aspect 30: A non-transitory computer-readable medium storing code for wireless communications at a network entity, the code comprising instructions executable by a processor to perform a method of any of aspects 16 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving a request for a level one beam report for a set of channel measurement resources, the request including a UE beam information request for an associated receive beam used for one or more corresponding measurements of at least a subset of the set of channel measurement resources;
measuring each measurement resource of the set of channel measurement resources using one or more receive beams; and
transmitting a measurement report that includes a set of measurements for the set of channel measurement resources, the measurement report including a beam level indication and a beam identification of the associated receive beam used for one or more corresponding measurements for at least the subset of the set of channel measurement resources.

2. The method of claim 1, wherein:
the beam level indication indicates one or more of a beam width of the associated receive beam or an array gain of the associated receive beam, wherein the beam width is indicated based at least in part on two or more beam width thresholds, and the array gain is indicated based at least in part on two or more array gain thresholds.

3. The method of claim 1, wherein the measurement report further includes one or more of an antenna panel identification of the associated receive beam, a measurement type of the associated receive beam, or any combinations thereof.

4. The method of claim 3, wherein the antenna panel identification indicates one or more antenna panels used at the UE for the associated receive beam.

5. The method of claim 3, wherein the measurement type indicates a first measurement type associated with two or more receive beams is associated with the corresponding measurement, or a second measurement type that indicates a single receive beam is associated with the corresponding measurement.

6. The method of claim 1, further comprising:
identifying one or more candidate beam level indications for one or more receive beams used for the one or more corresponding measurements of at least the subset of the set of channel measurement resources, the candidate beam level indications based at least in part on one or more predefined threshold beam widths, one or more configured beam levels and associated beam widths, or one or more UE-selected beam levels and associated beam widths; and
determining which of the one or more candidate beam level indications to provide with one or more measurements of the measurement report based at least in part on the beam width of the receive beam associated with the one or more measurements.

7. The method of claim 1, further comprising:
transmitting one or more of an indication of a total quantity of antenna panels at the UE, or an indication of one or more measurement types that can be reported by the UE.

8. The method of claim 1, further comprising:
receiving configuration information for one or more receive beam parameters to be reported with the measurement report during an initial access procedure.

9. The method of claim 1, further comprising:
receiving configuration information for one or more receive beam parameters to be reported with the measurement report as part of a channel state information report configuration.

10. The method of claim 1, wherein:
the measurement report includes one or more fields for the beam level indication and the beam identification of the associated receive beam, the one or more fields being predefined fields or network configured fields, wherein the one or more fields are each associated with a single channel measurement resource or are associated with all of the channel measurement resources of at least the subset of the set of channel measurement resources.

11. The method of claim 1, wherein:
the measurement report is provided with a channel state information (CSI) part-1 report, with a CSI part-2 report, or any combinations thereof.

12. The method of claim 1, further comprising:
receiving an indication of a transmission configuration indicator (TCI) state for one or more subsequent communications, the TCI state indicating a joint TCI state associated with a transmit beam from a network entity and a receive beam at the UE.

13. The method of claim 12, wherein:
the receive beam at the UE is indicated by one or more of a beam level indication or an antenna panel identification, and the UE determines the associated receive beam based on one or more reported beam level indications or antenna panel identifications provided in one or more measurement reports.

14. The method of claim 1, further comprising:
transmitting UE capability information that indicates a UE capability related to receive beam reporting associated with measurements in a measurement report.

15. The method of claim 14, wherein:
the UE capability information further indicates a UE capability to receive an indication of a transmission configuration indicator state for UE receive beams for one or more subsequent communications.

16. A method for wireless communications at a network entity, comprising:
transmitting, to a user equipment (UE), a request for a level one beam report for a set of channel measurement resources, the request including a UE beam information request for an associated receive beam used at the UE for one or more corresponding measurements of at least a subset of the set of channel measurement resources; and
receiving a measurement report that includes a set of measurements for the set of channel measurement resources, the measurement report including a beam level indication and a beam identification of the associated receive beam used at the UE for one or more corresponding measurements for at least the subset of the set of channel measurement resources.

17. The method of claim 16, wherein:
the beam level indication indicates one or more of a beam width of the associated receive beam or an array gain of the associated receive beam, wherein the beam width is indicated based at least in part on two or more beam width thresholds, and the array gain is indicated based at least in part on two or more array gain thresholds.

18. The method of claim 16, wherein the measurement report further includes one or more of an antenna panel identification of the associated receive beam, a measurement type of the associated receive beam, or any combinations thereof.

19. The method of claim 18, wherein the antenna panel identification indicates one or more antenna panels used at the UE for the associated receive beam.

20. The method of claim 18, wherein the measurement type indicates a first measurement type associated with two or more receive beams is associated with the corresponding measurement, or a second measurement type that indicates a single receive beam is associated with the corresponding measurement.

21-24. (canceled)
